(19) United States
(12) Patent Application Publication
(10) Pub. No.: US 2007/0158035 A1
(43) Pub. Date: Jul. 12, 2007

(54) LADDER CORD ASSEMBLY

(75) Inventors: Reine Wilhem Larsson, Myggenas (SE); Richard Gerardus Johannes Van Dijkman, Schiedam (NL); Paulus Wilfried Hentzepeter, Zaltbommel (NL)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Industries BV, El Rotterdam (NL)

(21) Appl. No.: 11/615,890

(22) Filed: Dec. 22, 2006

(30) Foreign Application Priority Data
Jan. 11, 2006 (EP) 06075061.9

(51) Int. Cl. E06B 9/30

(52) U.S. Cl. 160/168.1 R

(57) ABSTRACT

A connector for connecting a ladder cord in a venetian blind to the bottom rail of the venetian blind includes two portions with one portion being securable to the bottom rail of the venetian blind and the other portion permanently connected to the ladder cord. Interconnection of the portions of the connector thereby secure the ladder cord to the bottom rail at preselected positioning.

### CROSS-REFERENCE TO RELATED APPLICATION

This application claims priority to European Application No. 06075061.9, filed 11 Jan. 2006, and such application is hereby incorporated by reference as if fully disclosed herein.

### BACKGROUND OF THE INVENTION

1. Field of the Invention

The present invention relates to a ladder cord assembly for a Venetian blind, including a ladder cord and a connector, the connector being adapted for securing to a bottom rail of a Venetian blind.

2. Description of the Relevant Art

It has been proposed to connect a ladder cord to a connector, which connector is connectable to a bottom rail of a Venetian blind. Such a proposal is known from U.S. Pat. No. 2,574,609, but in this arrangement the connector is attached to the bottom rail by screws and the opposite ends of the ladder each have to be separately clamped to the connector. This manner of attachment is both cumbersome and time consuming in production.

It is an object of the present invention to overcome or ameliorate at least one of the disadvantages of the prior art. It is also an object of the present invention to provide alternative structures, which are less cumbersome in assembly and operation and which moreover, can be made relatively inexpensively. Alternatively it is an object of the invention to at least provide the public with a useful choice.

### BRIEF SUMMARY OF THE INVENTION

The present invention provides a ladder cord assembly for a Venetian blind, including a ladder cord and a connector, the connector having a first portion for securing to a bottom rail of a Venetian blind and a second portion that is permanently connected to the ladder cord. Such a ladder cord assembly can be easily positioned in a Venetian blind assembly machine and can be readily connected with a bottom rail; either prior to or, after assembling of the slats has been completed. The connector can be permanently attached to the ladder cord at any stage of the production prior to the insertion of slats, while the ladder cords can still be manipulated with every available freedom.

In one advantageous embodiment of ladder cord assembly according to the invention, the connector comprises a groove for receiving an end portion of the ladder cord. Such a groove will enhance the exact positioning of the ladder cord ends in respect of the connector.

In another advantageous embodiment of the ladder cord assembly according to the invention, the connector further includes a slot for receiving a lift cord. This will enable the connection of a lift cord to a bottom rail to be combined with connecting the ladder cord. In a further preferred embodiment the slot is positioned in the connector such that its entrance becomes closed once the connector is inserted in an opening in a bottom rail. Such an arrangement would prevent the lift cord from accidentally becoming detached.

It is further advantageous for the ladder cord assembly according to the invention, if the first portion of the connector is adapted to be releasably secured to a bottom rail. This makes it possible to replace damaged or faulty ladder cords during the life of the Venetian blind.

With the ladder cord assembly according to the invention, it is also particularly advantageous if the second portion is fused to the ladder cord. In manufacture this enables a quick and secure attachment of the ladder cord to the connector. When using this type of attachment with the ladder cord assembly according to the invention, preferably the connector is of polycarbonate and the ladder cord of polyester.

The invention will now be described in reference to a selection of preferred embodiments as illustrated in the accompanying drawings.

### BRIEF DESCRIPTION OF THE DRAWINGS

FIG. 1 is a perspective detail view of a lower end of ladder cord assembly according to the invention;

FIG. 2 is a perspective detail view of the ladder cord assembly of FIG. 1, with a bottom rail and a lift cord in an arrangement just prior to making the final connection to a bottom rail of a Venetian blind;

FIG. 3 is a further perspective detail view showing the elements of FIG. 2 as finally connected to one another;

FIG. 4A is a bottom elevation of a second embodiment of connector for use in the ladder cord assembly of the invention;

FIG. 4B is a side elevation of the connector of FIG. 4A;

FIG. 4C is an end elevation of the connector of FIG. 4A; and

FIG. 5 is a perspective view from above of the connector of FIGS. 4A to 4C, on a reduced scale.

### DESCRIPTION OF THE PREFERRED EMBODIMENTS

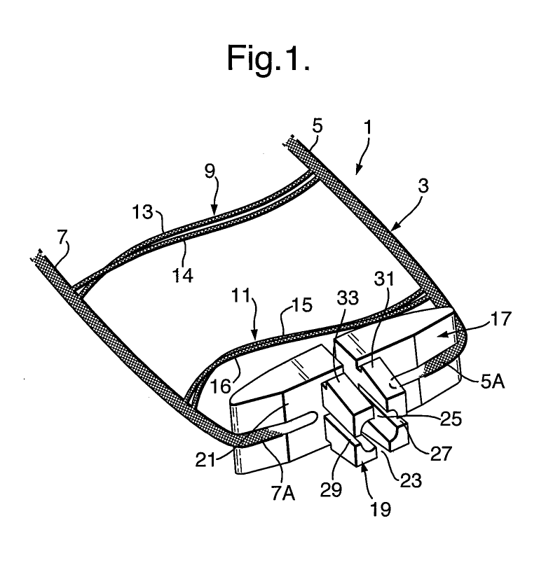

FIG. 1 shows a lower section of a ladder cord assembly in a Venetian blind, according to a first embodiment of the invention. A ladder cord 3 has opposite side cords 5,7 and a plurality of cross rungs 9, 11. In the embodiment illustrated, each cross rung 9, 11 is comprised of a pair of individual cords 13, 14, 15, 16, but other forms will also be possible. Opposite ends 5A, 7A of the ladder side cords 5, 7 are attached to a connector 17. The connector 17 has a first portion 19 for securing to a bottom rail of a Venetian blind (not shown) and a second portion 21 for receiving the ladder cord ends 5A, 7A in a permanently affixed manner. The permanent fixation may be obtained by an adhesive, such as a suitable hot melt glue, but preferably is obtained by welding or fusing. In particular the second portion 21 of the connector 17 can be fused to the ladder cord ends 5A, 7A if the connector 17 is of polycarbonate and the ladder cord 3 is of polyester.

The first portion 19 has been shaped to be flexible with a first slot 23, a second slot 25, a third slot 27 and a fourth slot 29. The first portion 19 is further provided with detent ridges 31, 33 to provide, together with the first to fourth slots 23, 25, 27, 29, a snap-fit connection with an opening in a bottom rail (to be described in more detail below).

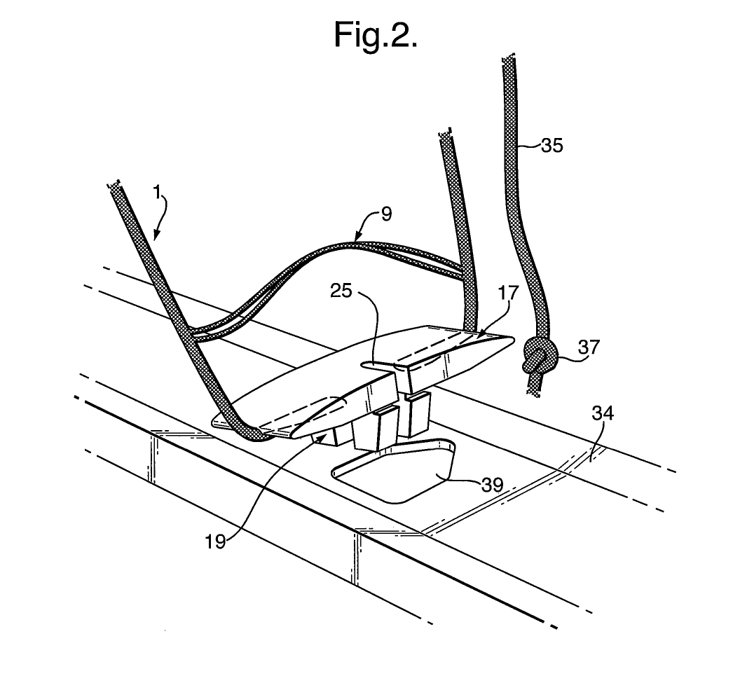

FIG. 2 shows the ladder cord assembly 1 in a position ready to be affixed to a bottom rail 34 together with a lift cord 35. The lift cord 35 as seen in FIG. 2 has a knot 37 at its end. While the lift cord 35 can pass through the second slot 25, the knot 37 will be retained within the cavity 32 (see FIG. 1). The bottom rail 34 further is provided with an opening 39 into which the first portion 19 of the connector 17 can be snap-fitted and retained afterwards.

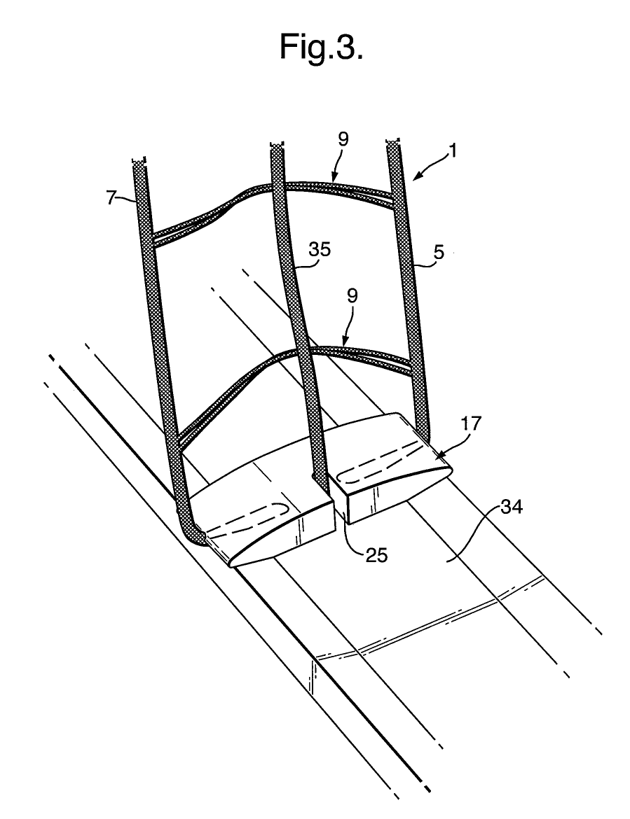

FIG. 3 shows the resulting assembly after the elements shown in FIG. 2 have been connected to one another. With the lift cord 35 engaged in the second slot 25 and the connector 17 held in the opening 39 of the bottom rail 34, all elements are securely connected. The bottom rail 34 can be raised by the lift cord 35 to collect the slats (not shown) each resting on one of the cross rungs 9 of the ladder cord 3. By lifting and lowering the individual ladder side cords 5, 7 these same slats (not shown) can be tilted for controlling light admittance, when the bottom rail 34 is in a lowered position. Although slats are deleted for clarity, it should be understood that in a Venetian blind, using the ladder cord assembly, each cross rung 9 (and 11) would be supporting a slat. Such a Venetian blind would also make use of at least two ladder cord assemblies 1 according to the invention.

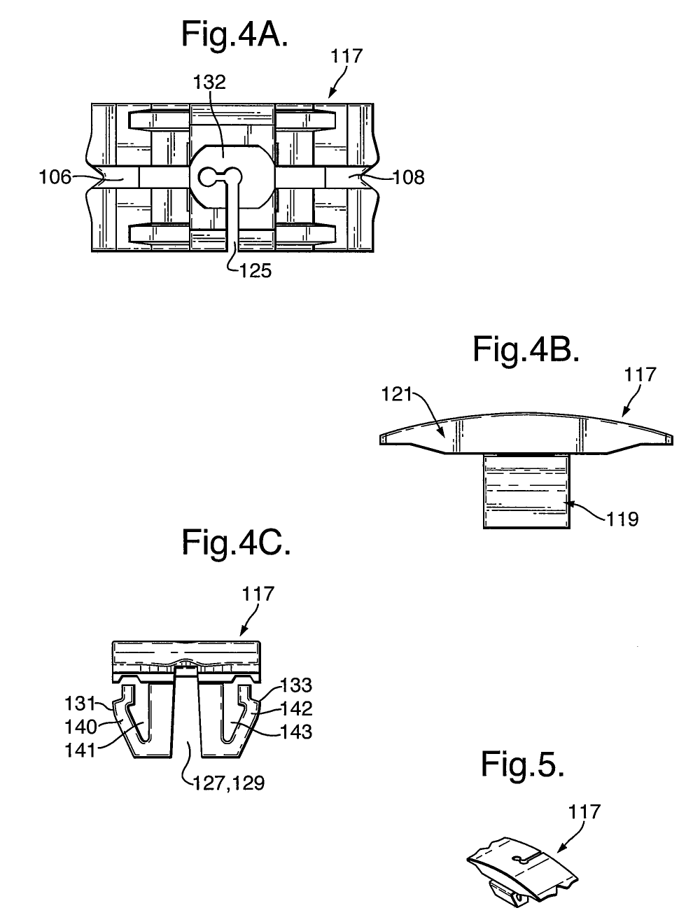

FIGS. 4A, 4B and 4C are bottom, side, and end elevations of a slightly modified embodiment of connector 117. Like the connector shown in FIG. 1, it has a first portion 119 for securing to a bottom rail of a Venetian blind (as described and shown in relation to the first embodiment) and a second portion 121 for receiving each of the opposite ladder side cord ends (not shown) in a permanently affixed manner in grooves 106, 108 respectively. The permanent fixation is again, preferably, a fusion between a polycarbonate material of the connector 117 and a polyester material of the ladder cord (not shown). The first portion 119 has been shaped to be flexible with a first slot 127 and a second slot 129. A third slot 125 is provided to allow entrance of a lift cord (not shown, but similar to lift cord 35 of FIG. 2) to pass into a cavity 132. A knot, or beaded end, of the lift cord is adapted to be retained within a cavity 132. The first portion 119 is further provided with detent ridges 131, 133 to provide, together with the first and second slots 127, 129 a snap-fit connection with an opening in a bottom rail (as already described above in relation to the first embodiment). In addition to the first embodiment the detent ridges 131,133 are rendered more flexible by being formed on arms 140, 142 that are separated from the body of the first portion 119 by spaces 141, 143. A perspective view from above of the modified connector 117 on a somewhat reduced scale is illustrated in FIG. 5.

It is thus believed that the operation and construction of the present invention will be apparent from the foregoing description. The term comprising when used in this description or the appended claims should not be construed in an exclusive or exhaustive sense but rather in an inclusive sense. Expressions such as: “means for . . . ” should be understood as: “component configured for . . . ” or “member constructed to . . . ” and should be construed to include equivalents for the structures disclosed. The use of expressions like: “critical”, “preferred”, “especially preferred” etc., is not intended to limit the invention. Features, which are not specifically or explicitly described or claimed, may be additionally included in the structure according to the present invention without deviating from its scope. The invention is further not limited to any embodiment herein described and, within the purview of the skilled person, modifications are possible which should be considered within the scope of the appended claims. Equally all kinematic inversions are to be considered within the scope of the present invention.

Directional and positional expressions, such as upper, lower, top, bottom, left, right, above, below, vertical, horizontal, clockwise, counter clockwise or like are generally used only to assist in understanding of the present invention as illustrated in the accompanying drawing figures. None of this should be construed to create limitations, as to position, orientation in actual use of the invention.

Similarly reference to either axially, radially or tangentially if used in the above is generally in relation to rotatable or cylindrical bodies of the elements described. Also where in the above reference is made to longitudinal or lateral this is in reference to the length or width directions respectively of elements, which have an oblong appearance in the accompanying drawings. Again this interpretation has only been used for ease of reference and should not be construed as a limitation of the shape of such elements.

1. Ladder cord assembly for a Venetian blind, including a ladder cord and a connector, the connector having a first portion for securing to a bottom rail of a Venetian blind and a second portion that is permanently connected to the ladder cord.

2. Ladder cord assembly according to claim 1, wherein the connector comprises a groove for receiving an end portion of the ladder cord.

3. Ladder cord assembly according to claim 1, wherein the connector further includes a slot for receiving a lift cord.

4. Ladder cord assembly according to claim 3, wherein the slot is positioned in the connector such that its entrance becomes closed once the connector is inserted in an opening in a bottom rail.

5. Ladder cord assembly according to claim 1, wherein the first portion is adapted to be releasably secured to a bottom rail.

6. Ladder cord assembly according to claim 1, wherein the second portion is fused to the ladder cord.

7. Ladder cord assembly according to claim 6, wherein the connector is of polycarbonate and the ladder cord of a polyester.
